(19) United States
(12) Patent Application Publication
(10) Pub. No.: US 2008/0094584 A1
(43) Pub. Date: Apr. 24, 2008

(54) PROJECTION APPARATUS AND LAMP THEREOF

(75) Inventors: Chun-Li Chen, Hsinchu (TW); Yu-Sung Lai, Hsinchu (TW); I-Hsien Liu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/828,337

(22) Filed: Jul. 25, 2007

(30) Foreign Application Priority Data
Oct. 23, 2006 (TW) 95138950

(51) Int. Cl. G03B 21/14; H01J 5/16

(52) U.S. Cl. 353/97; 313/116

(57) ABSTRACT

A projection apparatus including a lamp, a light valve and a projection lens is provided. The light valve is disposed on a transmission path of an illumination beam from the lamp for converting the illumination beam into an image beam, and the projection lens is disposed on a transmission path of the image beam. The lamp includes a lampshade, a filament, a first connector, a second connector, a lead wire and a diffuser. The lampshade has a bottom and a light-emitting section opposite to the bottom. The filament is disposed inside the lampshade, the first connector is disposed at the bottom and electrically connected to the filament, the second connector is disposed on the lampshade adjacent to the light-emitting section, the lead wire is connected between the filament and the second connector, and at least a part of the diffuser is disposed between the lead wire and the light-emitting section.

### CROSS-REFERENCE TO RELATED APPLICATION

This application claims the priority benefit of Taiwan application serial no. 95138950, filed Oct. 23, 2006. All disclosure of the Taiwan application is incorporated herein by reference.

### BACKGROUND OF THE INVENTION

1. Field of the Invention

The present invention generally relates to a projection apparatus, and more particularly, to a projection apparatus and a lamp thereof capable of improving the brightness non-uniformity of a frame.

2. Description of Related Art

FIG. 1A is a sectional diagram of a conventional parabolic lamp applied in a projection apparatus, while FIG. 1B is the front view of the parabolic lamp in FIG. 1A. Referring to FIGS. 1A and 1B, a conventional parabolic lamp 100 includes a parabolic lampshade 110, a filament 120, a first connector 130, a second connector 140 and a lead wire 150. The parabolic lampshade 110 has a bottom 112 and a light-emitting section 114 opposite to the bottom 112, while the filament 120 is disposed inside the parabolic lampshade 110. The first connector 130 is disposed at the bottom 112 and electrically connected to the filament 120. The second connector 140 is disposed on the parabolic lampshade 110 adjacent to the light-emitting section 114. The lead wire 150 is electrically connected between the filament 120 and the second connector 140.

In the above-mentioned parabolic lamp 100, the first connector 130 is suitable for connecting a connection point of the power supply (not shown), while the second connector 140 is suitable for connecting another connection point thereof (not shown). Since the second connector 140 herein is not directly connected to the filament 120, thus, the lead wire 150 is used to electrically connect the second connector 140 to the filament 120. In this way, the parabolic lamp 100 is started up once turned on the projection apparatus; therefore, the lead wire 150 is an indispensable component in the parabolic lamp 100.

The light ray 160 emitted from the filament 120 is reflected by the parabolic lampshade 110 into a parallel light beam 170, which is emitted out from the light-emitting section 114 in the direction perpendicular to the light-emitting section 114. However, a part of parallel light beam 170 would be blocked by the lead wire 150 during the light traveling, so that there is no light passing through the corresponding portion of the light-emitting section 114, which further results in brightness non-uniformity of the frame provided by the projection apparatus employing the parabolic lamp 100. More particularly, a shadow in the center of the frame is generated due to the light blockage of the lead wire 150.

### SUMMARY OF THE INVENTION

The present invention is related to a projection apparatus capable of displaying frames with uniform brightness.

The present invention is further related to a lamp capable of overcoming the phenomena of light not passing through the partial light-emitting section.

To achieve the above-mentioned or other advantages, the present invention provides a lamp, which includes a lampshade, a filament, a first connector, a second connector, a lead wire and a diffuser. The lampshade has a bottom and a light-emitting section opposite to the bottom, while the filament is disposed inside the lampshade. The first connector is disposed at the bottom and electrically connected to the filament. The second connector is disposed on the lampshade adjacent to the light-emitting section. The lead wire is electrically connected between the filament and the second connector, and at least a part of the diffuser is disposed between the lead wire and the light-emitting section.

To achieve the above-mentioned or other advantages, the present invention farther provides a projection apparatus, which includes the above-mentioned lamp, a light valve and a projection lens. The lamp is suitable for proving an illumination beam, the light valve is disposed on the transmission path of the illumination beam and suitable for converting the illumination beam into an image beam, and the projection lens is disposed on the transmission path of the image beam.

Since the lamp of the present invention employs a diffuser to diffuse the light ray passing around the lead wire, therefore, the present invention is able to overcome the disadvantage of the light not passing through the partial light-emitting section due to the light blockage by the lead wire as in the case of the prior art, and thus the projection apparatus employing the lamp may overcome the disadvantage of the non-uniformity of frame brightness caused by the projection apparatus employing the conventional lamp.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF TIE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a sectional diagram of a conventional parabolic lamp applied in a projection apparatus.

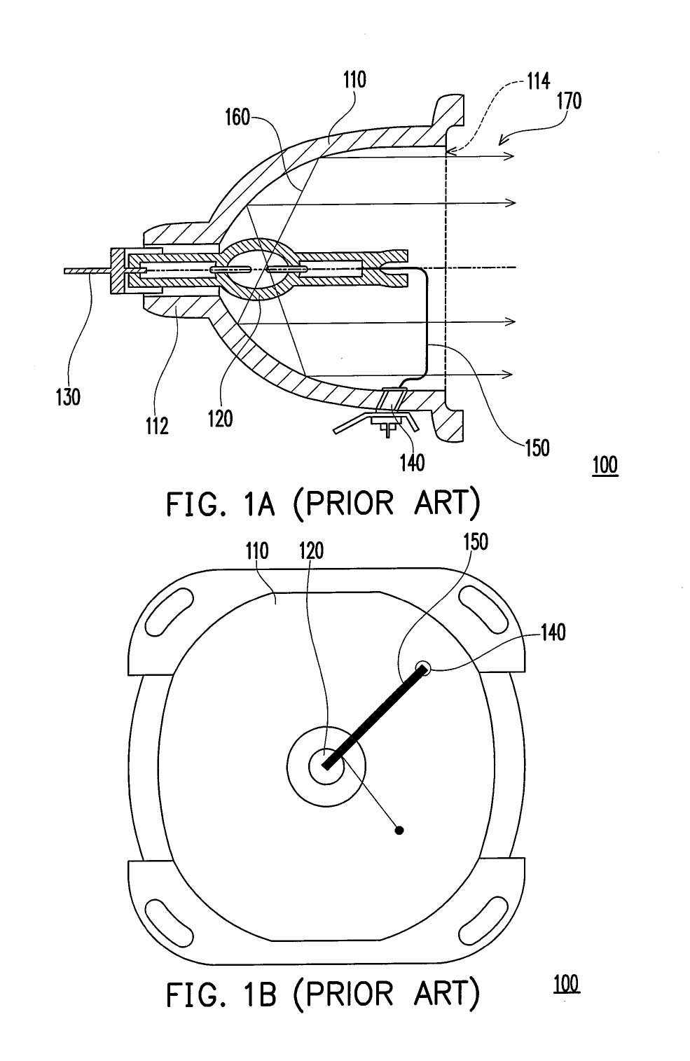

FIG. 1B is the front view of the parabolic lamp in FIG. 1A.

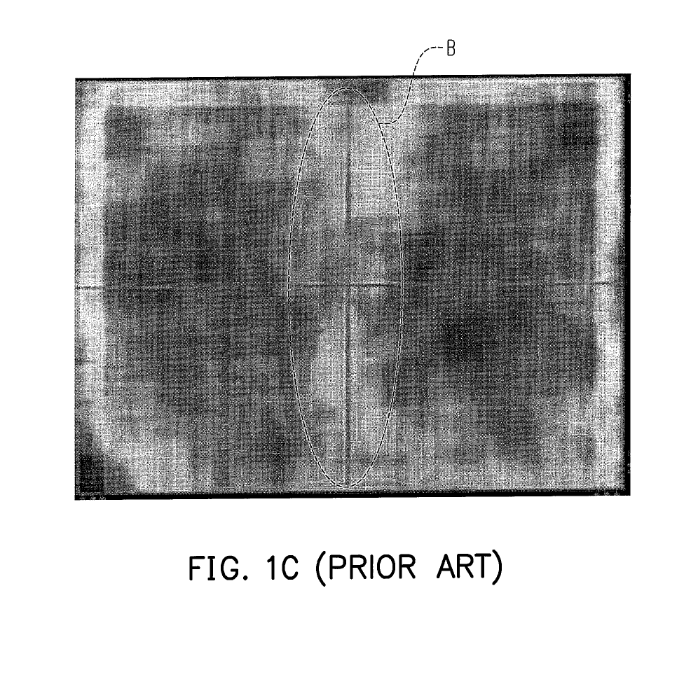

FIG. 2 is a diagram showing a projection apparatus according to an embodiment of the present invention.

FIG. 3A is a sectional diagram of the lamp in the projection apparatus shown by FIG. 2.

FIG. 3B is the front view of the lamp in FIG. 3A.

FIG. 4 is a sectional diagram of a lamp according to another embodiment of the present invention.

### DESCRIPTION OF THE EMBODIMENTS

It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected” and variations thereof herein are used broadly and encompass direct and indirect connections.

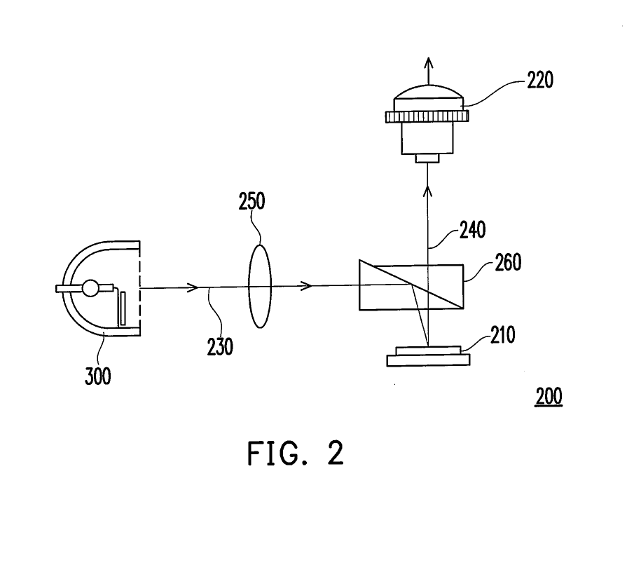

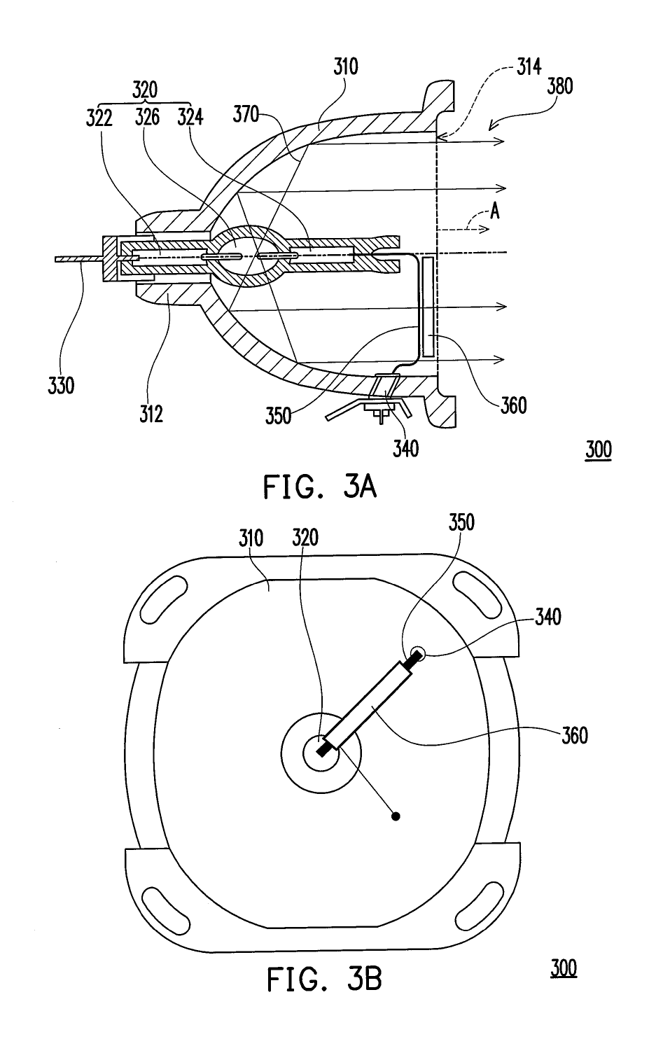

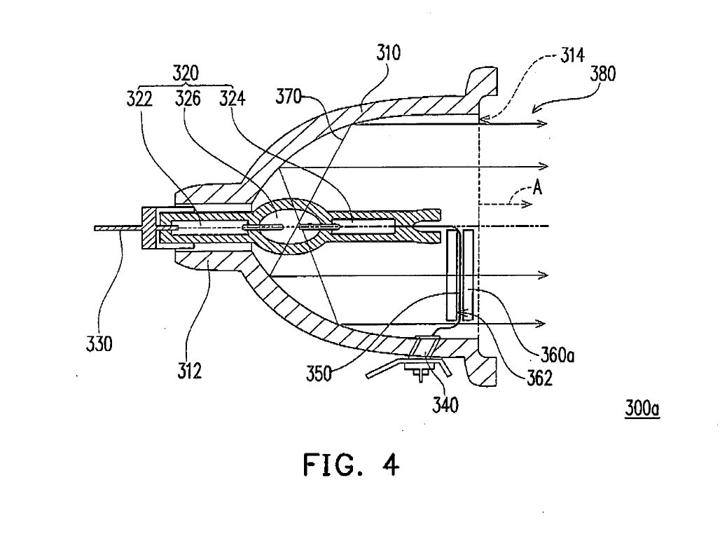

FIG. 2 is a diagram showing a projection apparatus according to an embodiment of the present invention, FIG. 3A is a sectional diagram of the lamp in the projection apparatus shown by FIG. 2 and FIG. 3B is the front view of the lamp in FIG. 3A. Referring to FIGS. 2, 3A and 3B, a projection apparatus 200 includes a lamp 300, a light valve 210 and a projection lens 220. The lamp 300 is suitable for providing an illumination beam 230, the light valve 210 is disposed on the transmission path of the illumination beam 230 and suitable for converting the illumination beam 230 into an image beam 240, and the projection lens 220 is disposed on the transmission path of the image beam 240 and suitable for projecting the image beam 240 onto a screen. In the embodiment, the light valve 210 is, for example, a reflective light valve such as a digital micro-mirror device (DMD) or a reflective liquid crystal on silicon panel (reflective LCOS panel) or a transmittive light valve such as a transmittive LCD panel. In addition, other optical components, for example, a lens 250 and a total internal reflection prism (TIR prism) 260, are usually disposed on the transmission path of the illumination beam 230 between the lamp 300 and the light valve 210; but the present invention does not limit the optical component disposed thereon.

The lamp 300 includes a lampshade 310, a filament 320, a first connector 330, a second connector 340, a lead wire 350 and a diffuser 360. The lampshade 310 has a bottom 312 and a light-emitting section 314 opposite to the bottom 312 and can be a parabolic lampshade. The filament 320 is disposed inside the lampshade 310. The first connector 330 is disposed at the bottom 312 and is electrically connected to the filament 320. The second connector 340 is disposed on the lampshade 310 adjacent to the light-emitting section 314. The lead wire 350 is connected between the filament 320 and the second connector 340. The diffuser 360 is disposed between the lead wire 350 and the light-emitting section 314, while the lead wire 350 and the diffuser 360 are arranged, for example, in a direction which is substantially parallel to the normal vector A of the light-emitting section 314. In addition, the diffuser 360 is, for example, a prism such as a semi-cylinder-shape diffuser or a polygonal-prism-shape diffuser; but the present invention does not limit the shape of the diffuser 360 as such.

The above-mentioned filament 320 may include a first electrode 322, a second electrode 324 and a luminous portion 326. The first electrode 322 is embedded in the bottom 312 and connected to the first connector 330, while the second electrode 324 is connected to the lead wire 350. The luminous portion 326 is connected between the first electrode 322 and the second electrode 324. The materials of the first electrode 322 and the second electrode 324 are a conductive material. In addition, the lampshade 310 is, for example, a parabolic lampshade, which enables the light ray 370 emitted from the luminous portion 326 to be a parallel light beam 380 (i.e. the illumination beam 230) and the parallel light beam 380 is emitted out from the light-emitting section 314 substantially in the direction perpendicular to the light-emit section 314.

In the embodiment, although a part of the parallel light beam 380 is blocked by the lead wire 350 during the light traveling towards the light-emitting section 314, but the light ray passing through the vicinity of the lead wire 350 would enter into the diffuser 360, and the diffuser 360 would diffuse the light ray to enable the partial light ray to be emitted out from the area of the light-emitting section 314 corresponding to the lead wire 350. Therefore, the disadvantage of the light not passing through the partial light-emitting section due to the blockage of the lead wire as in the case of the prior art can be overcome. In other words, no shadow in the region of the frame corresponding to the lead wire 350, for example, the center of the frame, can be generated due to the light blockage of the lead wire 350. Thus, the projection apparatus 200 of the present invention effectively promotes the brightness uniformity of the frame.

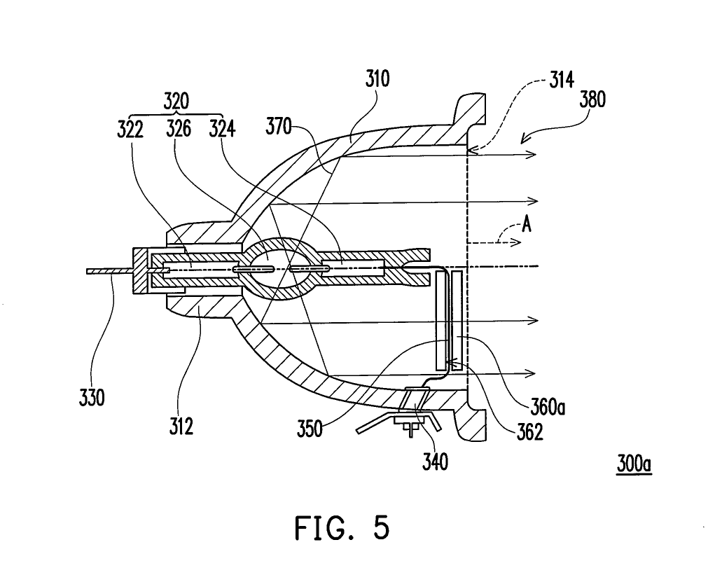

FIG. 4 is a sectional diagram of a lamp according to another embodiment of the present invention. Referring to FIG. 4, the lamp 300a of the embodiment is similar to the lamp 300 in FIG. 3A except for the position of the diffuser. In more detail, the diffuser 360a of the lamp 300a has a through hole 362, while the lead wire 350 passes through the through hole 362 and is enclosed by the diffuser 360a, which means the diffuser 360a sheathes the lead wire 350. The diffuser 360a is, for example, a cylinder-sleeveshape diffuser or a polygonal-sleeve-shape diffuser.

The lamp 300a of the embodiment has the same advantages as the lamp 300, thus, it is omitted to describe. In addition, the lamp 300 of the projection apparatus 200 in FIG. 2 can be replaced by the lamp 300a.

It should be noted that although the above-mentioned lamp takes the parabolic lampshade as an example, but the present invention does not limit the shape of the lampshade 310, which, for example, can be an elliptical lampshade or a lampshade with other appropriate shapes. Besides, the lamps 300 and 300a can be applied in other apparatuses as well.

In summary, since the lamp of the present invention employs a diffuser to diffuse the light ray passing through the vicinity of the lead wire, thus, it is possible that a part of the light ray is emitted out from the area of the light-emitting section corresponding to the lead wire, so that the disadvantage of light not passing through the partial light-emitting section due to the light blockage of the lead wire as in the case of the prior art may be overcome. This can also avoid a lower brightness area on the frame due to the light blockage of the lead wire. In short, the projection apparatus of the present invention is capable of providing frames with uniform brightness,

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A lamp, comprising:
a lampshade having a bottom and a light-emitting section opposite to the bottom;
a filament disposed inside the lampshade;
a first connector disposed at the bottom and electrically connected to the filament;
a second connector disposed on the lampshade adjacent to the light-emitting section;
a lead wire connected between the filament and the second connector; and
a diffuser, wherein at least a part of the diffuser is disposed between the lead wire and the light-emitting section.

2. The lamp according to claim 1, wherein the diffuser has a through hole, and the lead wire passes through the through hole and is enclosed by the diffuser.

3. The lamp according to claim 2, wherein the diffuser is a cylinder-sleeve-shape diffuser or a polygonal-sleeve-shape diffuser.

4. The lamp according to claim 1, wherein the diffuser is disposed between the lead wire and the light-emitting section, the lead wire and the diffuser are arranged in a direction and the direction is substantially parallel to a normal vector of the light-emitting section.

5. The lamp according to claim 4, wherein the diffuser is a semi-cylinder-shape diffuser or a polygonal-prism-shape diffuser.

6. The lamp according to claim 1, wherein the lampshade is a parabolic lampshade.

7. The lamp according to claim 1, wherein the lampshade is an elliptical lampshade.

8. The lamp according to claim 1, wherein the filament comprises:
a first electrode embedded in the bottom of the lampshade and connected to the first connector;
a second connector connected to the lead wire; and
a luminous portion connected between the first electrode and the second electrode.

9. A projection apparatus, comprising:
a lamp providing an illumination beam and comprising:
a lampshade having a bottom and a light-emitting section opposite to the bottom;
a filament disposed inside the lampshade;
a first connector disposed at the bottom and electrically connected to the filament;
a second connector disposed on the lampshade adjacent to the light-emitting section;
a lead wire connected between the filament and the second connector; and
a diffuser, wherein at least a part of the diffuser is disposed between the lead wire and the light-emitting section;
a light valve disposed on the transmission path of the illumination beam and converting the illumination beam into an image beam; and
a projection lens disposed on the transmission path of the image beam.

10. The projection apparatus according to claim 9, wherein the diffuser has a through hole, and the lead wire passes through the through hole and is enclosed by the diffuser.

11. The projection apparatus according to claim 10, wherein the diffuser is a cylinder-sleeve-shape diffuser or a polygonal-sleeve-shape diffuser.

12. The projection apparatus according to claim 9, wherein the diffuser is disposed between the lead wire and the light-emitting section, the lead wire and the diffuser are arranged in a direction and the direction is substantially parallel to a normal vector of the light-emitting section.

13. The projection apparatus according to claim 12, wherein the diffuser is a semi-cylinder-shape diffuser or a polygonal-prism-shape diffuser.

14. The projection apparatus according to claim 9, wherein the lampshade is a parabolic lampshade.

15. The projection apparatus according to claim 9, wherein the lampshade is an elliptical lampshade.

16. The projection apparatus according to claim 9, wherein the filament comprises:
a first electrode embedded in the bottom of the lampshade and connected to the first connector;
a second connector connected to the lead wire; and
a luminous portion connected between the first electrode and the second electrode.
